(19) United States
(12) Patent Application Publication
(10) Pub. No.: US 2006/0159772 A1
(43) Pub. Date: Jul. 20, 2006

(54) Fungicidal compositions

(76) Inventors: Carlo Garavaglia, Milan (IT); Luigi Mirenna, Milan (IT); Samuele Osti, Milan (IT); Osvaldo Puppin, Milan (IT)

Correspondence Address: HEDMAN & COSTIGAN P.C., 1185 AVENUE OF THE AMERICAS, NEW YORK, NY, 10036, US

(21) Appl. No.: 10/535,011

(22) PCT Filed: Nov. 18, 2003
(86) PCT No.: PCT/EP03/12943

§ 371 Date: Dec. 28, 2005

(30) Foreign Application Priority Data
Nov. 27, 2002 (IT) MI2002A002516

(51) Int. Cl. A01N 59/26; A01N 37/44; A01N 37/12

(52) U.S. Cl. 424/604; 514/538

(57) ABSTRACT

Fungicidal compositions are described, consisting of mixtures comprising salts of an alkaline or alkaline-earth metal, Mn or Zn of phosphorous acid and at least a second component selected from compounds having an antifungal activity. The component having an antifungal activity can be selected, for example, from IR5885, IR6141, copper (1) or copper (11) salts (such as copper oxychloride, copper hydroxide, tribasic copper sulfate), dithiocarbamates (such as mancozeb, zineb, propineb), folpet.

The present invention relates to fungicidal compositions.

In particular, the present invention relates to new compositions capable of controlling phytopathogen agents which cause considerable economical damage to agricultural crops.

More specifically, the present invention relates to the use of compositions based on a salt of alkaline or alkaline-earth metal, Mn or Zn of phosphorous acid, also called phosphites or phosphonates, in a mixture with at least another component having an antifungal activity.

The Applicant has surprisingly found that the compositions based on salts of phosphorous acid, object of the present invention, have surprising fungicidal activities and prove to be capable of controlling numerous diseases which can damage crops of considerable economical interest, such as, for example, vines, potatoes and tobacco.

With respect to analogous mixtures obtained with Fosetyl, an aluminum phosphonate having the same action mechanism, salts of phosphorous acid have surprisingly proved to have a higher synergic effect with the other components, at the same time having the advantage of a better profile from a toxicological and environmental point of view, as well as the advantage of a wider range of uses. The compositions, object of the present invention, unlike the analogous mixtures with Fosetyl, are, for example, capable of efficaciously controlling potato downy mildew, showing a high synergic effect.

The object of the present invention therefore relates to fungicidal compositions consisting of mixtures comprising A) at least one salt of an alkaline or alkaline-earth metal, Mn or Zn of phosphorous acid and B) at least a second fungicidal component. In particular, the fungicidal component B) can be selected from:
1) Cymoxanil, corresponding to 1-(2-cyano-2-methoxy imino-acetyl)-3-ethyl urea;
2) IR5885, a dipeptic compound corresponding to diastereoisomeric mixtures of methyl (S-(R,S)]-[3-(N-isopropoxycarbonylvalinyl)amino[-3-(4-chlorophenyl)propanoate in any proportion, or to one of the two diastereoisomeric forms S—R or S—S, considered singly;
3) Benalaxyl, corresponding to methyl N-(phenyl acetyl)-N-2,6-xylyl-RS-alaninate;
4) IR 6141, corresponding to methyl N-(phenyl acetyl)-N-2, 6-xylyl-R-alaninate;
5) Metalaxyl, corresponding to methyl N-(2-methoxy acetyl)-N-2,6-xylyl-RS-alaninate;
6) Mefenoxam, corresponding to methyl N-(2-methoxy acetyl)-N-2,6-xylyl-R-alaninate;
7) Oxadixyl, corresponding to 2-methoxy-N-(2-oxo-1,3-oxazolidin-3-yl)aceto-2′,6′-xylidide;
8) Ofurace, corresponding to DL-3-[N-chloroacetyl-N-(2,6-xylyl)-amino]-γ-butyrolactone;
9) Iprovalicarb, corresponding to O-(1-methyl-ethyl)-N-[2-methyl-1-[[[1-(4-methylphenyl)-ethyl]amino]carbonyl]propyl]carbamate, or Benthiavalicarb-isopropyl corresponding to O-isopropyl[(S)-1-{[(1R)-1-(6-fluoro-1,3-benzo-thiazol-2-yl)ethyl]carbamoyl-2-methylpropyl]-carbamate;
10) Azoxystrobin, corresponding to methyl (E)-2-[2-[6-(2-cyanophenoxy)-pyrimidin-4-yloxy]phenyl-3-methoxyacrylate;
11) Kresoxim-methyl corresponding to methyl (E)-methoxyimino-α-[(o-tolyloxy)-o-tolyl]-acetate;
12) Metominofen, corresponding to N-methyl-(E)-methoxyimino-(2-phenoxyphenyl)acetamide;
13) Acibenzolar, corresponding to methyl benzo-(1,2,3)thiadiazole-7-thiocarboxylate;
14) Famoxadone, corresponding to 5-methyl-5-(4-phenoxyphenyl)-3-(phenylamino)oxazolidin-2,4-dione;
15) Fenamidone, corresponding to 4-methyl-4-phenyl-1-(phenylamino)-2-methylthio-imidazolidin-5-one;
16) Cyazofamide, corresponding to 2-cyano-4-chloro-′5-(4-methylphenyl)-1-(N,N-dimethylaminosulfamoyl)-imidazole;
17) Fluazinam, corresponding to 3-chloro-N-(3-chloro-5-trifluoromethyl-2-pyridyl)-α,α,α-trifluoro-2,6-dinitro-p-toluidine;
18) Dimethomorph, corresponding to (E,Z)-4-[3-(4-chlorophenyl)-3-(3,4-dimethoxyphenyl)acryloyl]-morpholine; or
Flumorph (SYP-L190) corresponding to (E,Z)-4-[3-(4-fluorophenyl)-3-(3,4-dimethoxyphenyl)-acryloyl]morpholine;
19) Flumetover, corresponding to N,N-diethyl-[4-trifluoromethyl-6-(3,4-dimethoxyphenyl)]benzamide
20) Chlorothalonil, corresponding to 1,3-dicyano-2,4,5,6-tetrachlorobenzene;
21) Thiram, corresponding to bis-(dimethyl-thiocarbamoyl)disulfide(polymer);
22) Propineb, corresponding to the zinc salt of propylenebis(dithiocarbamate)(polymer);
23) Mancozeb, corresponding to the manganese and zinc salt of ethylenebis(dithiocarbamate)(polymer);
24) Maneb, corresponding to the manganese salt of ethylenebis(dithiocarbamate)(polymer);
25) Zineb, corresponding to the zinc salt of ethylenebis(dithiocarbamate)(polymer);
26) Dichlofluanide, corresponding to N-dichloro-fluoromethylthio-N′,N′-dimethyl-N-phenyl-sulfamide;
27) Tolylfluanide, corresponding to N-dichlorofluoro-methylthio-N′-N′-dimethyl-N-p-tolylsulfamide;
28) Captan, corresponding to N-(trichloromethylthio)cyclohex-4-ene-1,2-carboximide;
29) Folpet, corresponding to N-(trichloromethylthio)phthalimide;
30) Dithianon, corresponding to 5,10-dihydro-5,10-dioxonaphtho-[2,3-b]-1,4-dithiine-2,3-dicarbonitrile;
31) Etridiazole, corresponding to ethyl-3-trichloromethyl-1,2,4-thiadiazolyl ether;
32) Hymexazol, corresponding to 5-methylisoxazol-3-ol;
33) Protiocarb, corresponding to S-ethyl-(3-dimethylaminopropyl)thiocarbamate;
34) Propamocarb, corresponding to propyl (3-dimethylamino)propylcarbamate;
35) a copper (I) or copper (II) salt, such as copper oxychloride, copper hydroxide, or the copper sulfate;
36) Mepanipyrim, corresponding to N-(4-methyl-6-prop-1-inylpyrimidin-2-yl)aniline;
37) Pirymethanil, corresponding to N-(4,6-dimethylpyrimidin-2-yl)aniline;
38) Cyprodinil, corresponding to N-(4-methyl-6-cyclopropylpyrimidin-2-yl)aniline;
39) R-3-aminobutanoic acid or RS-3-aminobutanoic acid;
40) Zoxamide, corresponding to 3,5-dichloro-N-(3-chloro-1-ethyl-1-methyl-2-oxopropyl)-p-toluamide;
41) salicylic acid or its derivatives, such as copper salts of salicylic acid or of acetyl salicylic acid;
42) Trifloxystrobin, corresponding to methyl (E,E)-methoxyimino-{2-[1-(3-trifluoromethylphenyl)-ethylideneaminooxymethyl]phenyl}acetate;
43) Pyraclostrobin, corresponding to methyl N-(2-{[1-(4-chlorophenyl)-1H-pyrazol-3-yl]oxymethyl}phenyl)-N-methoxy carbamate;
44) Picoxystrobin, corresponding to methyl (E)-2-{2-[6-(trifluoromethyl)pyridin-2-yloxymethyl]-phenyl}-3-methoxyacrylate;
45) Ethaboxam, corresponding to N-(α-cyano-2-thenyl)-4-ethyl-2-(ethylamino)-5-thiazolecarboxamide.

The phosphorous acid salt A) is preferably a sodium, potassium; magnesium, manganese or zinc salt.

In the spirit of the present invention, component A) can be a single salt of an alkaline or alkaline-earth metal, Mn or Zn of phosphorous acid or a mix of said salts in any proportion.

Still in the spirit of the present invention, the salts of an alkaline or alkaline-earth metal, Mn or Zn of phosphorous acid, can be mono- or di-basic, or a mix of the same in any proportion.

In particular, component B) is preferably selected from IR5885, IR6141, copper (I) and copper (II) salts (such as copper oxychloride, copper hydroxide, tribasic copper sulfate), dithiocarbamates (such as, for example, mancozeb, zineb, propineb), folpet.

Even more preferably, component B) is selected from IR5885, IR6141, copper oxychloride and mancozeb.

Preferred fungicidal compositions, according to the present invention, consist of mixtures comprising A) a salt of an alkaline or alkaline-earth metal, Mn or Zn of phosphorous acid, and B) a second fungicide selected from IR5885 or IR6141, or salts of copper (I) or copper (II).

Preferred fungicidal compositions according to the present invention consist of mixtures comprising A) a salt of an alkaline or alkaline-earth metal, Mn or Zn of phosphorous acid, and B) two additional fungicides selected from the following couples: IR5885 and Mancozeb, or IR6141 and Mancozeb, or IR5885 and IR6141, or IR5885 and Cymoxanil, or IR5885 and copper (I) salts, or IR5885 and copper (II) salts, or IR6141 and copper (I) salts, or IR6141 and copper (II) salts.

Compound (1) is described in “The Pesticide Manual”, 1983, VII^{th} edition, British Crop Protection Council Ed., page 148.

Compounds (2) are described in Italian patent application No. MI98A002583.

Compound (3) is described in “The Pesticide Manual”, 1983, VII^{th} edition, British Crop Protection Council Ed., page 32.

Compound (4) is described in the patent application WO 98 26654 A2.

Compound (5) is described in the English patent GB 1,500,581.

Compound (6) is described in the patent application WO 96 01559 A1.

Compound (7) is described in the English patent GB 2,058,059.

Compound (8) is described in “Phytopatological News” (1978), Vol. 9, page 142.

Compounds (9) are described in patent applications EP 550,788 and EP 775696, respectively.

Compound (10) is described in European patent application EP 382,375.

Compound (11) is described in European patent application EP 253,213.

Compound (12), corresponding to the experimental monogram SSF-126, is described in the U.S. Pat. No. 5,185,242.

Compound (13), is described in the U.S. Pat. No. 4,931,581.

Compound (14) is described in “Brighton Crop Protection Conference—Pests and Diseases” 1996, Congress Acta.

Compound (15) is described in European patent application EP 629,616.

Compound (16), also called IKF916, is described in European patent application EP 705,823.

Compound (17) is described in European patent application EP 31,257.

Compounds (18) are described in European patent application EP 219,756 and in “Brighton Crop Protection Conference—Pests and Diseases” 2000, Congress Acta, respectively.

Compound (19) is described in European patent applications EP 360,701 and EP 611,232.

Compound (20) is described in “The Pesticide Manual”, 1983, VII^{th} edition, British Crop Protection Council Ed., page 120.

Compound (21) is described in “The Pesticide Manual”, 1983, VII^{th} edition, British Crop Protection Council Ed., page 534.

Compound (22) is described in “The Pesticide Manual”, 1983, VII^{th} edition, British Crop Protection Council Ed., page 469.

Compound (23) is described in “The Pesticide Manual”, 1983, VII^{th} edition, British Crop Protection Council Ed., page 339.

Compound (24) is described in. “The Pesticide Manual”, 1983, VII^{th} edition, British Crop Protection Council Ed., page 340.

Compound (25) is described in “The Pesticide Manual”, 1983, VII^{th} edition, British Crop Protection Council Ed., page 569.

Compound (26) is described in “The Pesticide Manual”, 1983, VII^{th} edition, British Crop Protection Council Ed., page 175.

Compound (27) is described in “The Pesticide Manual”, 1983, VII^{th} edition, British Crop Protection Council Ed., page 537.

Compound (28) is described in “The Pesticide Manual”, 1983, VII^{th} edition, British Crop Protection Council Ed., page 87.

Compound (29) is described in “The Pesticide Manual”, 1983, VII^{th} edition, British Crop Protection Council Ed., page 599.

Compound (30) is described in “The Pesticide Manual”, 1983, VII^{th} edition, British Crop Protection Council Ed., page 225.

Compound (31) is described in “The Pesticide Manual”, 1983, VII^{th} edition, British Crop Protection Council Ed., page 252.

Compound (32) is described in “The Pesticide Manual”, 1983, VII^{th} edition, British Crop Protection Council Ed., page 314.

Compound (33) is described in “The Pesticide Manual”, 1983, VII^{th} edition, British Crop Protection Council Ed., page 473.

Compound (34) is described in “The Pesticide Manual”, 1983, VII^{th} edition, British Crop Protection Council Ed., page 471.

Compounds (35) are easily found on the market.

Compound (38) is described in the patent application WO 95 15684.

Compounds (39) are described in European patent application EP 753,258.

Compound (40) is described in “Brighton Crop Protection Conference—Pests and Diseases” 1998, Congress Acta.

Compounds (41) are commercial products and their copper salts are described in Italian patent application No. MI 2001A002430.

Compound (42) is described in “Brighton Crop Protection Conference—Pests and Diseases” 1998, Congress Acta.

Compounds (43) and (44) are described in “Brighton Crop Protection Conference—Pests and Diseases” 2000, Congress Acta.

Compound (45) is described in European patent application No. EP 639574.

The fungicidal compositions comprising salts of an alkaline or alkaline-earth metal, Mn or Zn of phosphorous acid, with at least one of the compounds (1)-(41), object of the present invention, have a high fungicidal activity with respect to numerous fungal species.

A further object of the present invention relates to the use of compositions comprising salts of an alkaline or alkaline-earth metal, Mn or Zn of phosphorous acid, with at least one of the compounds (1)-(45), as fungicides.

Examples of pathogens controlled by said compositions, as well as examples of application crops, are listed hereunder for illustrative purposes only and with no limitative intention:
Plasmopara viticola (vines);
Phytophthora infestans (tomatoes, potatoes);
Phytophthora nicotianae (tobacco, ornamental plants);
Phytophthora palmivora (cacao);
Phytophthora cinnamomi (pineapples, citrus fruits);
Phytophthora capsici (peppers, tomatoes, cucurbitaceae);
Phytophthora cryptogea (tomatoes, thorn-bushes, ornamental plants);
Phytophthora megasperma (ornamental plants);
Phytophthora citri (citrus fruits);
Peronospora tabacina (tobacco);
Pseudoperonospora cubensis (cabbages, cucurbitaceae);
Pseudoperonospora humili (hops);
Bremia (salads).

The compositions object of the present invention are capable of exerting a considerable fungicidal activity, allowing preventive, protective, prophylactic, systemic, curative and eradicating treatment to be effected.

The compositions, object of the present invention, can be used in different amounts, depending on the crop, pathogen, environmental conditions and formulation adopted.

In general, the fungicidal compositions according to the present invention envisage the following application dosages per hectare:
1000-4000 g of phosphorous acid salt;
5-3500 g for each fungicide from 1) to 41), present in the composition.

The application of the compositions, object of the present invention, can be effected on any part of the plant, for example on the leaves, stems, branches and roots, or on the seeds themselves before sowing, or on the ground in which the plant grows.

The compositions, object of the present invention, are used in agronomical practice under various forms, such as, for example: dry powders, wettable powders, emulsifying concentrates, micro-emulsions, pastes, granules, solutions, suspensions, etc. The choice of the type of composition depends on the specific use.

The compositions are prepared in the known manner, for example by diluting or dissolving the active substance with a solvent medium and/or a solid diluent, possibly in the presence of surface-active agents.

Solid diluents or carriers which can be used are: silica, kaolin, bentonite, talc, infusorial earth, dolomite, calcium carbonate, magnesia, chalk, clays, synthetic silicates, attapulgite, sepiolite.

Various solvents can be used as liquid diluents in addition to water, for example aromatic solvents (xylols, or mixtures of alkyl benzenes), paraffins (oil fractions), alcohols (methanol, propanol, butanol, octanol, glycerin), amines, amides (N,N-dimethyl formamide, N-methyl pyrrolidone), ketones (cyclohexanone, acetone, acetophenone, isophorone, ethyl amyl ketone), fatty acids (for example vegetable oils, such as rape oil, sun flower oil), esters (isobutyl acetate, methyl esters of fatty acids obtained, for example, from the transesterification of vegetable oils).

Sodium, calcium, triethanol amine salts, or triethyl amine of alkyl sulphonates, alkyl aryl sulphonates, polyethoxylated alkyl phenols, fatty acids condensed with ethylene oxide, polyoxyethylated fatty acids, polyoxyethylated esters of sorbitole, lignin sulfonates, can be used as surface-active agents.

The compositions can also contain special additives for particular purposes, such as, for example, adhesion agents, such as gum Arabic, polyvinyl alcohol, polyvinyl pyrrolidone.

In the fungicidal compositions, object of the present invention, the concentration of active substances ranges from 0.1 to 98%, preferably from 0.5 to 90%.

Other compatible active principles can be added, if desired, to the compositions, object of the present invention, such as, for example, phyto-regulators, antibiotics, herbicides, insecticides, fertilizers. The following examples are provided for purely illustrative and non-limiting purposes of the present invention. The potassium phosphite (K₂HPO₃+KH₂PO₃) solution utilized in the following examples 1-4 is obtained by neutralizing at pH 6.6 with potassium hydroxide a solution of 500 g/l of phosphorous acid in water.

### EXAMPLE 1

Determination of the fungicidal efficacy against downy mildew (Plasmopara viticola) of compositions object of the present invention, in preventive application to vine leaves.

The efficacy field tests for the control of Plasmopara viticola are carried out using an experimental random block scheme which envisages 4 repetitions and 6-8 plants per repetition.

The vines, Barbera variety, are treated by spraying both sides of the leaves with a composition based on potassium phosphite (K₂HPO₃+KH₂PO₃) in water solution in an extemporaneous mix with the compound IR6141 (compound nr. 4); or in an extemporaneous mix with the compound IR5885 (compound nr.2), suitably formulated as a wettable powder 25W; or in an extemporaneous mix with a composition based on the compound IR5885 and copper oxychloride, formulated as a wettable powder.

The tests are carried out by treating the mixtures of a solution of potassium phosphite with IR 6141 at a fixed cadence every 7 days, and the mixtures of said solution of potassium phosphite with IR 5885, or IR 5885 and copper oxychloride, at a fixed cadence every 10 days.

The measurements, effected when the presence of the pathogen agent is revealed on the non-treated blank lot, are made on both the leaves and bunches.

The leaf measurement is effected by counting 100 leaves of vine per lot (for a total of 400 leaves) and determining the percentage of leaf surface affected by the disease.

The bunch measurement is effected by analyzing all of them and considering the percentage of damaged surface.

The data relating to field tests carried out in Piemonte and Emilia with compositions based on potassium salts of phosphorous acid in an extemporaneous mix with the compound IR5885 (compound nr. 2); or in an extemporaneous mix with the compound IR6141 (compound nr. 4); or in an extemporaneous mix with a composition based on the compound IR5885 and copper oxychloride (example of compound nr. 35) in comparison with the same in a mix with Aluminum Fosetyl, are shown in tables 1-2.

TABLE 1
Average of 4 tests carried out on vines in
Italy, during the experimental season 2002

| | | % disease | % disease |
|---|---|---|---|
| | Dosages active | control | control |
| | principle (g/hl) | leaves | bunch |
| IR6141 + potassium phosphite | 10 + 120 | 95 | 93 |
| IR6141 + aluminum Fosetyl | 10 + 120 | 92 | 90 |
| Non-treated blank (*) | | 78 | 45 |

(*) % disease index

TABLE 2
Average of 5 tests carried out on vines in
Italy, during the experimental season 2002

| | | % disease | % disease |
|---|---|---|---|
| | Dosages active | control | control |
| | principle (g/hl) | leaves | bunch |
| IR5885 + potassium phosphite | 12 + 120 | 94 | 97 |
| IR5885 + aluminum Fosetyl | 12 + 120 | 92 | 94 |
| IR5885 + copper oxychloride + | 12 + 90 + 120 | 99 | 99 |
| potassium phosphite | | | |
| IR5885 + copper oxychloride + | 12 + 90 + 120 | 93 | 96 |
| aluminum Fosetyl | | | |
| Non-treated blank (*) | | 84 | 65 |

(*) % disease index

### EXAMPLE 2

Determination of the fungicidal efficacy against downy mildew (Plasmopara viticola) in preventive application to vine leaves.

Analogously to what is described in example 1, field efficacy tests are effected for the control of Plasmopara viticola on vines.

The vine plants, Barbera variety, are sprayed with a composition based on potassium phosphite (K₂HPO₃+KH₂PO₃) in water solution in an extemporary mix with copper oxychloride (example of compound nr. 35), formulated with a wettable powder 50WP.

Tests are carried out by treatment at a fixed cadence every 7 days.

The data relating to field tests carried out in Piemonte and Emilia with compositions-based on potassium salts of phosphorous acid in an extemporaneous mix with copper oxychloride compared with the analogous mix with Aluminum Fosetyl, are indicated in table 3.

TABLE 3
Average of 2 tests carried out on vines in
Italy, during the experimental season 2002

| | Dosages active | % disease | % disease con- |
|---|---|---|---|
| | principle (g/hl) | control leaves | trol bunch |
| Copper oxychloride + | 80 + 120 | 81 | 95 |
| potassium phosphite | | | |
| Copper oxychloride + | 80 + 120 | 58 | 73 |
| aluminum Fosetyl | | | |
| Non-treated | | 45 | 87 |
| blank (*) | | | |

(*) % disease index

### EXAMPLE 3

Determination of the fungicidal efficacy against potato downy mildew (Phytophthora infestans) of compositions object of the present invention, in preventive application to the leaves of potato plants.

The efficacy field tests for the control of Phytophthora infestans are carried out using a random block experimental scheme which envisages 4 repetitions and 18-20 plants per repetition.

The potato plants, Miura variety, are treated by spraying both sides of the leaves with a composition based on potassium phosphite (K₂HPO₃+KH₂PO₃) in water solution in an extemporaneous mix with a blend of compounds IR6141 (compound nr. 4) and mancozeb (compound nr. 23); or with a blend of the compounds IR5885 (compound nr. 2) and mancozeb (compound nr. 23). Both blends are suitably formulated as a wettable powder WP.

The tests are carried out by treating the mixtures of a solution of potassium phosphite with IR 6141 at a fixed cadence every 7 days, and the mixtures of said solution of potassium phosphite with IR 5885, at a fixed cadence every 10 days.

The measurements are carried out when the presence of the pathogen agent is revealed on the non-treated blank lot.

The leaf measurement is effected by counting 100 potato leaves per lot (for a total of 400 leaves) and determining the percentage of leaf surface affected by the disease.

The data relating to field tests carried out in Great Britain and France with compositions of potassium salts of phosphorous acid in an extemporaneous mix with a composition of compounds IR5885 (compound nr. 2) and mancozeb (compound nr. 23); or in an extemporaneous mix with the composition of compounds IR6141 (compound nr.4) and mancozeb (compound nr. 23) compared with analogous blends without potassium salts of phosphorous acid, are indicated in tables 4 and 5.

The activity of the potassium salt of phosphorous acid alone, allows the possible synergy of the composition to be determined, by analyzing the results obtained using the Limpel formula (“Pesticide Science” (1987), vol. 19, pages 309-315):
E=x+y−(x*y/100)
wherein:
E is the fungicidal activity expected, in the absence of synergic effects, from a mix obtained by mixing g. x of compound X with g. y of compound Y;
x is the activity of compound X when used alone with a dosage of g. x;
y is the activity of compound Y when used alone
with a dosage of g. y;

As the ratio between the experimental value of the composition (85%) and the calculated value of E (71%) is higher than 1, a synergic effect is verified.

TABLE 4
Average of 3 tests carried out on potato
plants in Great Britain, during the experimental season
2002

| | Dosages active | % disease control |
|---|---|---|
| | principle (g/hl) | leaves |
| IR6141 + mancozeb + | 80 + 1300 + | 85 |
| potassium phosphite | + 1400 | |
| IR6141 + mancozeb | 80 + 1300 | 62 |
| Potassium phosphite | 1400 | 23 |
| Non-treated | | 95 |
| blank (*) | | |

(*) % disease index

TABLE 5
Average of 4 tests carried out on potato
plants in France, during the experimental season 2002

| | Dosages active | % disease control |
|---|---|---|
| | principle (g/hl) | leaves |
| IR5885 + mancozeb + | 120 + 1200 + | 90 |
| potassium phosphite | + 1400 | |
| IR5885 + mancozeb | 120 + 1200 | 76 |
| Non-treated | | 89 |
| blank (*) | | |

(*) % disease index

### EXAMPLE 4

Determination of the fungicidal efficacy against downy mildew (Plasmopara viticola) in preventive application to vine leaves in greenhouse.

Leaves of vine plants, cv. Dolcetto, grown up in pots in conditioned environment at 25° C. and 60% relative humidity, were sprayed on both sides with hydroacetonic solutions (20% of acetone by volume) of the compounds under testing, the potassium phosphite (K₂HPO₃+KH₂PO₃) aqueous solutions and the mixtures of both components.

Seven days after the treatments, the leaves of treated plants and untreated controls were sprayed on the lower surface with aqueous suspension of Plasmopara viticola conidia (200.000 conidia/ml); after beeing kept for 24 h at 21° C. in environment moist at saturation, the plants were transfered to other conditioned environment at 70% relative humidity and 21° C. for 7 days.

After this period the degree of infection was evaluated and the activity of the compounds tested was expressed as % of disease control in comparison to the untreated controls: 100=healty plant; 0=completely infected plant.

In tables 6-20 are reported the results obtained for the compounds tested alone and in mixture with potassium phosphite at the indicated dosages. When the % disease control value found is higher than the value expected applying the Limpel formula (see Example 3), a synergic effect is verified.

TABLE 6
Activity of potassium phosphite + cymoxanil
(compound 1) against Plasmopara viticola on vine leaves.

| | Dosages active | % Disease Control: | |
|---|---|---|---|
| Compound tested | principle (ppm) | found | expected |
| cymoxanil | 30 | 59 | — |
| potassium phosphite | 60 | 35 | — |
| cymoxanil + potassium phosphite | 30 + 60 | 80 | 73.35 |

TABLE 7
Activity of potassium phosphite + metalaxyl
(compound 5) against Plasmopara viticola on vine leaves.

| | Dosages active | % Disease Control: | |
|---|---|---|---|
| Compound tested | principle (ppm) | found | expected |
| metalaxyl | 0.20 | 45 | — |
| potassium phosphite | 60 | 35 | — |
| metalaxyl + potassium phosphite | 0.20 + 60 | 76 | 64.25 |

TABLE 8
Activity of potassium phosphite + mefenoxam
(compound 6) against Plasmopara viticola on vine leaves.

| | Dosages active | % Disease Control: | |
|---|---|---|---|
| Compound tested | principle (ppm) | found | expected |
| mefenoxam | 0.10 | 48 | — |
| potassium phosphite | 60 | 35 | — |
| mefenoxam + potassium phosphite | 0.10 + 60 | 77 | 66.20 |

TABLE 9
Activity of potassium phosphite + iprovalicarb
against Plasmopara viticola on vine leaves.

| | Dosages active | % Disease Control: | |
|---|---|---|---|
| Compound tested | principle (ppm) | found | expected |
| iprovalicarb | 0.45 | 50 | — |
| potassium phosphite | 60 | 35 | — |
| iprovalicarb + potassium phosphite | 0.45 + 60 | 84 | 67.50 |

TABLE 10
Activity of potassium phosphite + benthia-
valicarb against Plasmopara viticola on vine leaves.

| | Dosages active | % Disease Control: | |
|---|---|---|---|
| Compound tested | principle (ppm) | found | expected |
| benthiavalicarb | 0.25 | 47 | — |
| potassium phosphite | 60 | 35 | — |
| benthiavalicarb + potassium | 0.25 + 60 | 80 | 65.55 |
| phosphite | | | |

TABLE 11
Activity of potassium phosphite + azoxystrobin (compound 10)
against Plasmopara viticola on vine leaves.

| | |
|---|---|
| Dosages active | % Disease Control: |

| Compound tested | principle (ppm) | found | expected |
|---|---|---|---|
| azoxystrobin | 0.11 | 69 | — |
| potassium phosphite | 60 | 35 | — |
| azoxystrobin + | 0.11 + 60 | 85 | 79.85 |
| potassium phosphite | | | |

TABLE 12
Activity of potassium phosphite + famoxadone (compound 14)
against Plasmopara viticola on vine leaves.

| | |
|---|---|
| Dosages active | % Disease Control: |

| Compound tested | principle (ppm) | found | expected |
|---|---|---|---|
| famoxadone | 0.45 | 56 | — |
| potassium phosphite | 60 | 35 | — |
| famoxadone + | 0.45 + 60 | 81 | 71.40 |
| potassium phosphite | | | |

TABLE 13
Activity of potassium phosphite + fenamidone (compound 15)
against Plasmopara viticola on vine leaves.

| | |
|---|---|
| Dosages active | % Disease Control: |

| Compound tested | principle (ppm) | found | expected |
|---|---|---|---|
| fenamidone | 10 | 60 | — |
| potassium phosphite | 60 | 35 | — |
| fenamidone + | 10 + 60 | 85 | 74.00 |
| potassium phosphite | | | |

TABLE 14
Activity of potassium phosphite + cyazofamide (compound 16)
against Plasmopara viticola on vine leaves.

| | |
|---|---|
| Dosages active | % Disease Control: |

| Compound tested | principle (ppm) | found | expected |
|---|---|---|---|
| cyazofamide | 15 | 68 | — |
| potassium phosphite | 60 | 35 | — |
| cyazofamide + | 15 + 60 | 87 | 79.20 |
| potassium phosphite | | | |

TABLE 15
Activity of potassium phosphite + dimethomorph (compound 18)
against Plasmopara viticola on vine leaves.

| | |
|---|---|
| Dosages active | % Disease Control: |

| Compound tested | principle (ppm) | found | expected |
|---|---|---|---|
| dimethomorph | 0.45 | 73 | — |
| potassium phosphite | 60 | 35 | — |
| dimethomorph + | 0.45 + 60 | 91 | 82.45 |
| potassium phosphite | | | |

TABLE 16
Activity of potassium phosphite + chlorothalonil (compound 20)
against Plasmopara viticola on vine leaves.

| | |
|---|---|
| Dosages active | % Disease Control: |

| Compound tested | principle (ppm) | found | expected |
|---|---|---|---|
| chlorothalonil | 7.5 | 46 | — |
| potassium phosphite | 60 | 35 | — |
| chlorothalonil + | 7.5 + 60 | 72 | 64.90 |
| potassium phosphite | | | |

TABLE 17
Activity of potassium phosphite + zoxamide (compound 40)
against Plasmopara viticola on vine leaves.

| | |
|---|---|
| Dosages active | % Disease Control: |

| Compound tested | principle (ppm) | found | expected |
|---|---|---|---|
| zoxamide | 0.45 | 54 | — |
| potassium phosphite | 60 | 35 | — |
| zoxamide + | 0.45 + 60 | 76 | 70.10 |
| potassium phosphite | | | |

TABLE 18
Activity of potassium phosphite + oxadixyl (compound 7)
against Plasmopara viticola on vine leaves.

| | |
|---|---|
| Dosages active | % Disease Control: |

| Compound tested | principle (ppm) | found | expected |
|---|---|---|---|
| oxadixyl | 0.20 | 49 | — |
| potassium phosphite | 60 | 35 | — |
| oxadixyl + | 0.20 + 60 | 74 | 66.85 |
| potassium phosphite | | | |

TABLE 19
Activity of potassium phosphite + ofurace (compound 8)
against Plasmopara viticola on vine leaves.

| | |
|---|---|
| Dosages active | % Disease Control: |

| Compound tested | principle (ppm) | found | expected |
|---|---|---|---|
| ofurace | 0.20 | 53 | — |
| potassium phosphite | 60 | 35 | — |
| ofurace + | 0.20 + 60 | 79 | 69.45 |
| potassium phosphite | | | |

TABLE 20
Activity of potassium phosphite + fluazinam (compound 17)
against Plasmopara viticola on vine leaves.

| | |
|---|---|
| Dosages active | % Disease Control: |

| Compound tested | principle (ppm) | found | expected |
|---|---|---|---|
| fluazinam | 20 | 48 | — |
| potassium phosphite | 60 | 35 | — |
| fiuazinam + | 20 + 60 | 71 | 66.20 |
| potassium phoshite | | | |

1. Fungicidal compositions characterized in that they comprise A) at least one salt of an alkaline or alkaline-earth metal, Mn or Zn of phosphorous acid and B) at least a second fungicidal component.

2. The fungicidal compositions according to claim 1, characterized in that the fungicidal component B) is selected from:
1) Cymoxanil, corresponding to 1-(2-cyano-2-methoxy imino-acetyl)-3-ethyl urea;
2) IR5885, a dipeptic component corresponding to diastereoisomeric mixtures of methyl[S-(R,S)]-[3-(N-isopropoxycarbonylvalinyl)-amino]-3-(4-chloro-phenyl)propanoate in any proportion, or to one of the two diastereoisomeric forms S—R or S—S, considered singly;
3) Benalaxyl, corresponding to methyl N-(phenyl acetyl)-N-2,6-xylyl-RS-alaninate;
4) IR 6141, corresponding to methyl N-(phenyl acetyl)-N-2,6-xylyl-R-alaninate;
5) Metalaxyl, corresponding to methyl N-(2-methoxy acetyl)-N-2,6-xylyl-RS-alaninate;
6) Mefenoxam, corresponding to methyl N-(2-methoxy acetyl)-N-2,6-xylyl-R-alaninate;
7) Oxadixyl, corresponding to 2-methoxy-N-(2-oxo-1,3-oxazolidin-3-yl)aceto-2′,6′-xylidide;
8) Ofurace, corresponding to DL-3-[N-chloroacetyl-N-(2,6-xylyl)-amino]-γ-butyrolactone;
9) Iprovalicarb, corresponding to O-(1-methyl-ethyl)-N-[2-methyl-1-[[[1-(4-methyl-phenyl)-ethyl]amino]carbonyl]propyl]carbamate, or Benthiavalicarb-isopropyl corresponding to O-isopropyl[(S)-1-{[(1R)-1-(6-fluoro-1,3-benzothiazol-2-yl)ethyl]-carbamoyl-2-methylpropyl]carbamate;
10) Azoxystrobin, corresponding to methyl(E)-2-[2-[6-(2-cyanophenoxy)-pyrimidin-4-yloxy]phenyl-3-methoxy acrylate;
11) Kresoxym-methyl corresponding to methyl(E)-methoxyimino-α-[(o-tolyloxy)-o-tolyl]-acetate;
12) Metominofen, corresponding to N-methyl-(E)-methoxyimino-(2-phenoxyphenyl)acetamide;
13) Acibenzolar, corresponding to methyl benzothiadiazole-7-thiocarboxylate;
14) Famoxadone, corresponding to 5-methyl-5-(4-phenoxyphenyl)-3-(phenylamino)oxazo-lydin-2,4-dione;
15) Fenamidone, corresponding to 4-methyl-4-phenyl-1-(phenylamino)-2-methylthioimidazo-lydin-5-one;
16) Cyazofamide, corresponding to 2-cyano-4-chloro-5(4-methylphenyl)-1-(N,N-dimethylaminosulfamoyl)imidazole;
17) Fluazinam, corresponding to 3-chloro-N-(3-chloro-5-trifluoromethyl-2-pyridyl)-α,α,α-trifluoro-2,6-dinitro-p-toluidine;
18) Dimethomorph, corresponding to (E,Z)-4-[3-(4-chlorophenyl)-3-(3,4-dimethoxyphenyl)-acryloyl]morpholine; or
Flumorph (SYP-L190) corresponding to (E,Z)-4-[3-(4-fluorophenyl)-3-(3,4-dimethoxyphenyl)-acryloyl]morpholine;
19) Flumetover, corresponding to N,N-diethylamide of 4-trifluoromethyl-6-(3,4-dimethoxyphenyl)-benzoic acid;
20) Chlorothalonil, corresponding to 1,3-dicyano-2,4,5,6-tetrachlorobenzene;
21) Thiram, corresponding to bis-(dimethyl-thiocarbamoyl)disulfide(polymer);
22) Propineb, corresponding to the zinc salt of propylenebis(dithiocarbamate)(polymer);
23) Mancozeb, corresponding to the manganese and zinc salt of ethylenebis(dithiocarbamate)(polymer);
24) Maneb, corresponding to the manganese salt of ethylenebis(dithiocarbamate)(polymer);
25) Zineb, corresponding to the zinc salt of ethylenebis(dithiocarbamate)(polymer);
26) Dichlofluanide, corresponding to N-dichloro-fluoromethylthio-N′,N′-dimethyl-N-phenyl sulfamide;
27) Tolylfluanide, corresponding to N-dichloro-fluoro-methylthio-N′-N′-dimethyl-N-p-tolylsulfamide;
28) Captano, corresponding to N-(trichloro-methylthio)cyclohex-4-ene-1,2-carboximide;
29) Folpet, corresponding to N-(trichloro-methylthio)phthalimide;
30) Dithianon, corresponding to 5,10-dihydro-5,10-dioxonaphthol-[2,3-b]-1,4-dithi-in-2,3-dicarbo-nitrile;
31) Etridiazole, corresponding to ethyl-3-trichloromethyl-1,2,4-thiadiazolyl ether;
32) Hymexanol, corresponding to 5-methylisoxazol-3-ole;
33) Protiocarb, corresponding to S-ethyl-(3-dimethylaminopropyl)thiocarbamate;
34) Propamocarb, corresponding to propyl-(3-dimethylaminopropyl)carbamate;
35) A copper (I) or copper (II) salt, such as copper oxychloride, copper hydroxide, or the copper sulfate;
36) Mepanipyrim, corresponding to N-(4-methyl-6-prop-1-inylpyrimidin-2-yl)aniline;
37) Pirymethanil, corresponding to N-(4,6-dimethyl-pyrimidin-2-yl) aniline;
38) Cyprodinil, corresponding to N-(4-methyl-6-cyclopropylpyrimidin-2-yl)aniline;
39) R-3-amino butanoic acid or RS-3-amino butanoic acid;
40) Zoxamide, corresponding to 3,5-dichloro-N-(3-chloro-1-ethyl-1-methyl-2-oxopropyl)-p-toluamide;
41) Salicylic acid or its derivatives, such as copper salts of salicylic acid or of acetyl salicylic acid;
42) Trifloxystrobin, corresponding to methyl(E,E)-methoxyimino-{2-[1-(3-trifluoromethylphenyl)-ethylideneaminooxymethyl]phenyl}acetate;
43) Pyraclostrobin, corresponding to methyl N-(2-{[1-(4-chlorophenyl)-1H-pyrazol-3-yl]oxymethyl}phenyl)-N-methoxy carbamate:
44) Picoxystrobin, corresponding to methyl (E)-2-{2-[6-(trifuoromethyl)pyridin-2-yloxymethyl]-phenyl}-3-methoxyacrylate;
45) Ethaboxan, corresponding to N-(α-cyano-2-thenyl)-4-ethyl-2-(ethylamino)-5-thiazolecarboxamide.

3. The fungicidal compositions according to claim 1, characterized in that the phosphorous acid salt A) is selected from sodium, potassium, magnesium, manganese and zinc salt.

4. The fungicidal compositions according to claim 1, characterized in that component A) is a single salt or a mix of salts of phosphorous acid in any proportion.

5. The fungicidal compositions according to claim 1, characterized in that component A) is a mono- or di-basic salt, or a mixture of the same in any proportion.

6. The fungicidal compositions according to claim 2, characterized in that component B) is selected from IR5885, IR6141, copper (I) and copper (II) salts (such as copper oxychloride, copper hydroxide, tribasic copper sulfate), dithio-carbamates (such as, for example, mancozeb, zineb, propineb), folpet.

7. The fungicidal compositions according to claim 2, characterized in that component B) is selected from IR5885, IR6141, copper oxychloride and mancozeb.

8. The fungicidal compositions according to claim 2, characterized in that they consist of mixtures comprising A) a salt of an alkaline or alkaline-earth metal, Mn or Zn of phosphorous acid, and B) a second fungicide selected from IR5885 or IR6141, or salts of copper (I) or copper (II).

9. The fungicidal compositions according to claim 2, characterized in that they consist of mixtures comprising
A) a salt of an alkaline or alkaline-earth metal, Mn or Zn of phosphorous acid, and B) two additional fungicides selected from IR5885 and Mancozeb, or IR6141 and Mancozeb, or IR5885 and IR6141, or IR5885 and Cymoxanil, or IR5885 and copper (I) salts, or IR5885 and copper (II) salts, or IR6141 and copper (I) salts, or IR6141 and copper (II) salts.

10. The fungicidal compositions according to any of the previous claims, characterized in that the components are present in the following application dosages per hectare:
1000-4000 g of phosphorous acid salt;
5-3500 g for each fungicide from 1) to 41), present in the composition.

11. The fungicidal compositions according to claim 1, characterized in that they are formulated as dry powders, wettable powders, emulsifying concentrates, micro-emulsions, pastes, granules, solutions, suspensions, etc.

12. The fungicidal compositions according to claim 1 characterized in that they comprise other compatible active principles such as phyto-regulators, antibiotics, herbicides, insecticides, fertilizers.

13. The fungicidal compositions according to claim 1, characterized in that the concentration of active substances ranges from 0.1 to 98%, preferably from 0.5 to 90%.

14. Use of the compositions according to claim 1 as fungicides in the agronomical field.

15. Use according to claim 1, for the control of phytopathogen fungi such as Plasmopara viticola (vines);
Phytophthora infestans (tomatoes, potatoes); Phytophthora nicotianae (tobacco, ornamental plants);
Phytophthora palmivora (cacao); Phytophthora cinnamomi (pineapples, citrus fruits); Phytophthora capsici (peppers, tomatoes, cucurbitaceae); Phytophthora cryptogea (tomatoes, thorn-bushes, ornamental plants); Phytophthora megasperma (ornamental plants); Phytophthora citri (citrus fruits); Peronospora tabacina (tobacco); Pseudoperonospora cubensis (cabbages, cucurbitaceae); Pseudoperonospora humili (hops); Bremia (salads).

16. Method for controlling phytopathogen fungi in crops of agricultural and horticultural interest, using the compositions according to claim 1.

17. The method according to claim 16, characterized in that the application is effected on any part of the plant by application on the leaves, stems, branches and roots, or on the seeds themselves before sowing, or on the ground in which the plant grows.
